(19) United States
(12) Patent Application Publication
(10) Pub. No.: US 2005/0009501 A1
(43) Pub. Date: Jan. 13, 2005

(54) Method and network node for providing security in a radio access network

(76) Inventor: Sami Kekki, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/489,790

(22) PCT Filed: Sep. 26, 2002
(86) PCT No.: PCT/IB02/03972

(30) Foreign Application Priority Data
Sep. 27, 2001 (DE) 101 47 739.2

(51) Int. Cl. H04M 1/68; H04M 3/16

(52) U.S. Cl. 455/410

(57) ABSTRACT

The present invention relates to a method, a system and a network node for providing security in a radio access network, wherein an information conveyed in a signalling message of an application protocol of said radio access network is used to derive or create a security association to be used between communicating network nodes of said radio access network. The conveyed information may be an IP address or a UDP datagram used for deriving the security association from a respective database. Alternatively, the conveyed information may be a security parameter index or a security association information conveyed in a new information element of the signalling message. This information is then used for creating a new Security Association between the communicating network nodes. Thereby, a separate connection or protocol is not required for the security procedures. Moreover, the whole network control system does not have to be involved in the transfer, because the endpoints of encryption are in corresponding network elements of the radio access network.

### FIELD OF THE INVENTION

The present invention relates to a method, a system and network node for providing security in a radio access network (RAN), in particular a transport network layer of a Universal Mobile Telecommunications System (UMTS) Terrestrial RAN (UTRAN). Furthermore, the question how to manage security associations and how to convey information in the cellular network is answered.

### BACKGROUND OF THE INVENTION

The UMTS system consists of a number of logical network elements that each have a defined functionality. In the standards, the network elements are grouped based on similar functionality, or based on which sub-network they belong to. Functionally, the network elements are grouped into the Radio Access Network (RAN or UTRAN) which handles all radio-related functionality, and the core network (CN) which is responsible for switching and routing calls and data connections to external networks. To complete the system, a terminal device or user equipment (UE) provides an interface to a user.

For the 3GPP UTRAN Release 5 specification, an IP (Internet Protocol) based Transport Network Layer (TNL) is going to be specified, where IP transport is targeted to be an alternative for ATM/AAL2 (Asynchronous Transfer Mode/ATM Adaptation Layer 2) based TNL that is already provided in the Release 99 and Release 4 UTRAN specifications. With IP transport it is expected to gain cost efficiency as operators can use their existing IP transport infrastructure for UTRAN traffic.

In order to allow the sharing of IP transport infrastructure the security aspects need to be paid attention to. In UMTS the encryption of the user data is performed in the Serving Radio Network Controller (SRNC). However, this ciphering performed in Layer 2 of the air interface aims at protecting the confidentiality of the data in the radio interface only. It is still seen necessary to enable secure transport of all data over terrestrial UTRAN interfaces, both for confidentiality as well as for integrity and non-repudiation purposes.

IP Security (IPSec) is a suite of protocols that seamlessly integrate security features, such as authentication, integrity, and/or confidentiality, into IP. Using the IPSec protocols, one can create an encrypted and/or authenticated communication path, depending upon the protocols used, between two peers. This path is referred to as a tunnel. A peer is a device, such as a client, router, or firewall, that serves as an endpoint for the tunnel. More information about the IPSec architecture can be found in the IETF (Internet Engineering Task Force) specification RFC2401. The combination of how to protect the data, what data to protect (based on service), and between what points the data is to be protected (the tunnel peers, or endpoints) is called a security association (SA). SAs define which protocols and encryption algorithms should be applied to sensitive data packets, which packets are considered sensitive, and the keying material to be used by the two IPSec peers. Thus, ensuring the security refers mainly to the question of how to establish the SAs between the communicating nodes while the management of the SAs refers mainly to the question of how to assign user streams to (existing) SAs. More information about SAs can be gathered from the IETF specification RFC2410.

### SUMMARY OF THE INVENTION

It is an object of the present invention to provide a method and network node for ensuring security in radio access networks.

This object is achieved by a method as claimed in claims 1 and 20, and a system and a network node as claimed in claims 21 and 25, respectively.

Accordingly, a signalling message of an application protocol of the cellular network is used for transferring security parameters over the interface. Therefore, a separate connection or protocol is not required for transferring the security information. Moreover, the whole network control system does not have to be involved in the transfer, because the endpoints of encryption are in corresponding network elements of the radio access network. The remaining network between those corresponding network nodes is not aware of the information in the secure tunnel.

First, it is possible to provide in a database a mapping information for mapping network node addresses to respective available security associations. Said database may be a local database in a network node or a centralized database. The conveyed information could be an information about the IP addresses and/or UDP ports of said communicating network nodes. At the sending network node said mapping information relating to the receiving network node is checked and a security association based on said checking step can be determined.

Second, a security association could be determined at the receiving network node by a security information contained within said received message. Said security information could be a security parameter index (SPI). Further, there may be provided a predetermined specific information for conveying an additional information required for creating said security association.

Moreover, said conveying of information may be performed by using an existing security association for said signalling message. In most of the cases, said deriving or creating of a security association will be performed during set-up of said communication.

Said conveyed information can be conveyed within an information field of said signalling message. Such information field may be a container, a transport layer address information filed, or a predetermined specific information field.

Further, it should be noted that a security association may be signalled separately for both communication directions.

Said application protocol of said radio access network may be a RNSAP (radio network subsystem application part), NBAP (node B application part) or RANAP (radio access network application part) protocol. So it is possible that said signalling message is a message of e.g. the NBAP, RNSAP or RANAP protocol.

In a further development of the invention, it is possible to determine a security association at the sending node based on the type of user stream, wherein said type is determined based on a service of said user stream.

Finally, said conveying of information between network nodes can be performed by providing a transparent container information element in an application protocol message. Said transparent container information element will be used for conveying said information. That means said information is not targeted for said application protocol but for the transport network layer and its protocols.

Further advantageous developments are defined in the dependent claims.

### BRIEF DESCRIPTION OF THE DRAWINGS

In the following, the present invention will be described in greater detail based on preferred embodiments with reference to the accompanying drawings, in which:

FIG. 1 shows a schematic block diagram of a network architecture of a radio access network, in which the present invention can be implemented,

FIG. 2 shows a signalling diagram indicating a forwarding of a security parameter between network elements of the radio access network, according to a second preferred embodiment,

FIG. 3 shows a signalling diagram indicating a conveyance of relevant information required in SA creation between network elements of the radio access network, according to a third preferred embodiment,

FIG. 4 shows schematic diagram indicating the security environment according to the preferred embodiments, and

FIG. 5 shows a general protocol model for UTRAN interfaces, indicating those parts involved in the security provision according to the preferred embodiments.

### DESCRIPTION OF THE PREFERRED EMBODIMENTS

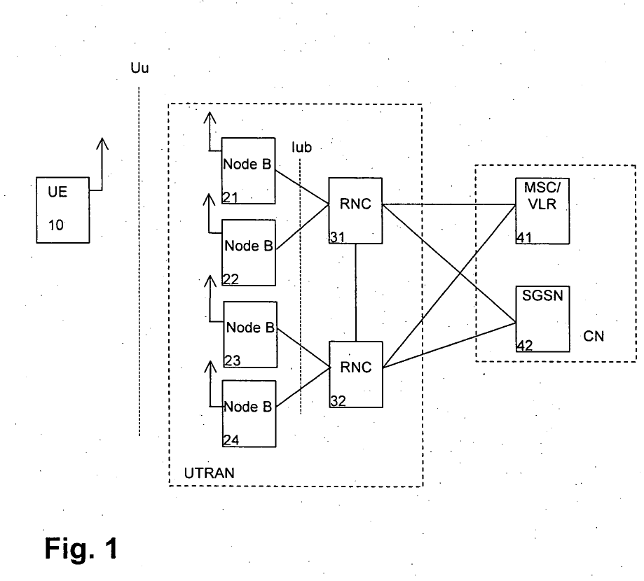

The preferred embodiments will now be described based on a UMTS network architecture in which a core network CN is connected to a UTRAN, as indicated in FIG. 1.

According to FIG. 1, a user equipment (UE) 10 is connected via a radio interface to two radio network sub-systems (RNSs) (controlled by RNCS) of the UTRAN. Each RNS comprises Node Bs 21, 22 and 23, 24 which are arranged to convert the data flow between an Uu interface (provided between the UE 10 and the respective Node B) and Iub interfaces (provided between a respective Radio Network Controller (RNC) 31 and 32 and the corresponding Node Bs 21, 22 and 23, 24). However, it is noted, that the term “Node B” may be replaced by the more generic term “base station” which has the same meaning. Each RNC 31, 32 owns and controls the radio resources in its domain, i.e. the Node Bs 21, 22 and 23, 24, respectively, connected to it. The RNC 31, 32 is the service access point for all services the UTRAN provides for the core network CN. The core network CN comprises at least one Mobile Services Switching Center/Visitor Location Register (MSCNLR) 41 having a switching function (MSC) and database (VLR) serving the UE 10 in its current location for circuit switched (CS) services. The MSC function is used to switch CS transactions, and the VLR function holds a copy of a visiting user's service profile, as well as more precise information on the location of the UE 10 within the serving system. The part of the core network which is accessed via the MSCNLR 41 is referred to as the CS domain.

Furthermore, the core network CN comprises a Serving GPRS (General Packet Radio Services) Support Node (SGSN) 42 having a functionality similar to that of the MSCNLR 41 but being typically used for packet switched (PS) services. The part of the network that is accessed via the SGSN 42 is referred to as the PS domain and may be used to provide a connection to IP based networks.

According to the preferred embodiments, the basic assumption is that there is provided one or more SAs between two communicating UTRAN nodes (e.g., an RNC and a Node B) for both directions of communication. From the viewpoint of the present invention, it is irrelevant whether the SA is of a tunnel mode type or a transport mode type. Also it is assumed that the signalling association between the two UTRAN nodes is secured. This implies that the application protocol signalling is secure over the TNL.

An existing SA is either re-used (i.e. shared) by the new user stream or a new SA is established for the new user stream. A user stream represents an Iu bearer (in case of the Iu interface between the UTRAN and the CN) or a Radio Bearer (in case of the Iur interface between the RNCs 31, 32 and/or the Iub interface). The user stream is identified in the IP based TNL of the UTRAN Release 5 specification by using the destination&originating UDP (User Datagram Protocol) Port and the destination&originating IP Address of the IP packet conveying the data belonging to the corresponding user stream. A UTRAN node may have one or several IP addresses. The IP addresses and UDP ports assigned to the user stream are negotiated during the set-up of the corresponding radio bearer and Iu bearer, by using the Radio Network System Application Part (RNSAP) protocol (via the Iur interface), the Node B Application Part (NBAP) protocol (via the Iub interface) and Radio Access Network Application Part (RANAP) protocol (via the Iu interface). These are the application protocols of the UTRAN Radio Network Layer.

In the following, a way to use the existing SAs for a new user stream between the two communicating UTRAN nodes is described as a first preferred embodiment.

Here it is assumed that there exists more than one SA between the two communicating UTRAN nodes (e.g., RNC and Node B) on the same interface (e.g. Iub interface). In this case the most straight-forward approach in selecting the SA to be used in either direction is to use a mapping between the IP addresses and/or UDP ports and the SA. Logically this mapping is stored in a security associations database of the UTRAN nodes. The security association database can be either a local database in a UTRAN node or it can be a centralized database somewhere in the network, accessible by all involved UTRAN (and CN) nodes.

During the connection (i.e. user stream) set-up, the IP addresses and UDP ports are exchanged in an information field, e.g. the Transport Layer Address Information field or a similar field, of the respective application protocol of the UTRAN Radio Network Layer. As soon as the negotiation is complete, the sending node can determine the SA to be used in the Transport Network Layer by checking the SA database entry matching with the address information.

The receiving end or node determines the used SA by inspecting the Security Parameters Index (SPI) included in the received IP datagram.

The other alternative is to determine the needed SA in the sending Node by inspecting the type of user stream while it is set-up. The relevant information is obtained from the Radio Network Layer and it can be e.g. the UMTS service class of the user stream (conversational/streaming/interactive/background) or any other information that is available.

The table below is a simplistic illustration of the mapping between IP, UDP and SPI as described above.

| IP address (dest/orig) | ###.###.###.aaa | ###.###.###.aaa | ###.###.###.aab | ###.###.###.aab |
|---|---|---|---|---|
| UDP port range (dest/orig) | 0000-32767 | 32768-65535 | 0000-32767 | 32768-65535 |
| SPI | 2345678 | 3456789 | 45678901 | 56789012 |

In the following, a way how to negotiate the SA to be used between the two communicating UTRAN nodes is described as a second preferred embodiment.

Here it is assumed that there are more than one SA existing between the two communicating UTRAN nodes. There can be cases where one or the other or both nodes benefit from the possibility to indicate the SA to be used for the user stream a priori, while the corresponding radio bearer or Iu bearer is set-up. The criteria to use one specific SA may be implementation dependent, e.g. dependent on the way how the security functionality has been implemented in the node (i.e. load balancing, etc.). The ability to signal the SA to be used beforehand allows the decoupling of the transport layer addresses and the SA. It is noted that in its normal case the SA is uniquely identified only with the corresponding IP address (i.e., the SPI does not have a global significance).

The SA negotiation may be performed as follows:

A new information element (IE) is introduced in the corresponding UTRAN application protocol (i.e. NBAP, RNSAP or RANAP). This new IE conveys the Security Parameter Index (SPI) of the given Security Association (SA). As the SA is generally unidirectional, it needs to be signalled separately for both directions, unless the two SAs were coupled. The new IE constitutes a container that is used for the conveyance of the security information or any other information between the two end points. The notion of container results from the fact that while the application protocol in general is used for operations in the Radio Network Layer, the security information conveyed by it is used by the Transport Network Layer of the UTRAN protocol structure, as explained later in more detail.

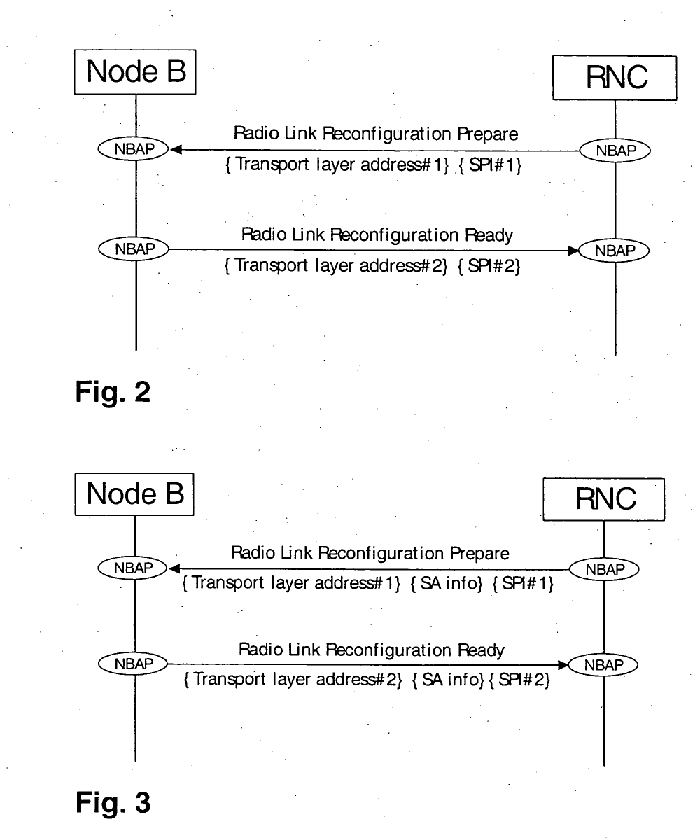

FIG. 2 shows a signalling diagram indicating the above mechanism according to the second preferred embodiment for a signalling between a Node B and an RNC. In the Radio Link Reconfiguration Prepare signalling message of the NBAP protocol, the transport layer address #1 and the security parameter index SPI#1 of the RNC are conveyed in respective IEs from the RNC to the Node B. Then, the Radio Link Reconfiguration Ready signalling message of the NBAP protocol can be used to convey the transport layer address #2 and the security parameter index SPI#2 of the Node B in respective IEs from the Node B to the RNC. The new IE conveying the SPI of the SA used towards the node who signalled it, can be transparent for the Radio Network Layer. That is, the IE serves as a container for the TNL specific security information. This is in line with the notion of separating the Transport Network Layer and the Radio Network Layer of the UTRAN.

SPI#1 indicates the SA that is to be used in the Node B to RNC direction, in similar fashion as the transport layer address #1 indicates the destination transport layer address in the Node B to RNC direction. SPI#2 and Transport layer Address #2 are the corresponding information for the RNC to Node B direction.

In the following, a way how to create the SA on demand between the two communicating UTRAN nodes is described as a third preferred embodiment.

Sometimes there may be a case where a new SA is needed on-demand for the user streams between the communicating UTRAN nodes. In the IETF specification RFC 2409, an Internet Key Exchange (IKE) protocol for negotiating and providing authenticated keying material for security association in a protected manner is specified. Setting up the SA by using IKE (main mode, aggressive mode and quick mode of the protocol) consists of several message exchanges between the peer users, since both the key and the encryption algorithm are negotiated. This inevitably introduces delay in the creation process (round-trip delays plus processing delays).

In UTRAN the delay in creating a new SA should be minimized because of its critical role in network service quality (as perceived by the end user) and in radio interface performance (e.g., during a handover from one cell to another).

According to the third embodiment, the on-demand creation of the SA is streamlined by integrating it in the application protocol of the given UTRAN interface (i.e. NBAP, RNSAP or RANAP). It is emphasized that most of the UTRAN nodes have at least one existing SA before any on-demand creation of a new SA takes place. This existing SA can be used by the application protocol signalling. Thus, the creation procedure as described in the IETF specification RFC 2409 can be made shorter and simpler, since authentication may be omitted as a whole, the encryption/hash algorithms can be re-used, etc.

In the third preferred embodiment, an additional transparent SA information container IE is introduced in the corresponding application protocol messages to allow the conveyance of all relevant information needed in the SA creation.

FIG. 3 shows a signalling diagram indicating the above SA creation mechanism according to the third preferred embodiment for a signalling between the Node B and the RNC, similar to the diagram of FIG. 2. In the Radio Link Reconfiguration Prepare signalling message of the NBAP protocol, the transport layer address #1, the security parameter index SPI#1 and an additional SA information of the RNC are conveyed in respective IEs (i.e. containers) from the RNC to the Node B. Then, the Radio Link Reconfiguration Ready signalling message of the NBAP protocol can be used to convey the transport layer address #2, the security parameter index SPI#2 and an additional SA information of the Node B in respective IEs from the Node B to the RNC.

Thereby, the application protocol signalling can be used for conveying the SA information required for on-demand creation of the SA.

It is to be noted that the names of the application protocol messages in FIGS. 2 and 3 are only illustrative and are to be seen as examples. Instead of the Radio Link Reconfiguration message of the NBAP protocol, similar messages of the RNSAP protocol or the Radio Access Bearer (RAB) Request message of the RANAP protocol can be used. In general, the security information could be allowed or made available if needed in any such xxxAP protocol message which is used for requesting a new communication channel or which is reconfiguring an existing communication channel over any of the RAN interfaces, e.g. Dedicated Channel (DCH), Shared Channel or Common Channel (CCH) in Iur and Iub interfaces or an RAB in the Iu interface. As examples, in RANAP, the RAB Assignment Request message may be used, while in NBAP and RNSAP, the Radio Link Setup Request message, Radio Link Addition Request, and/or Radio Link Reconfiguration Request messages may be used.

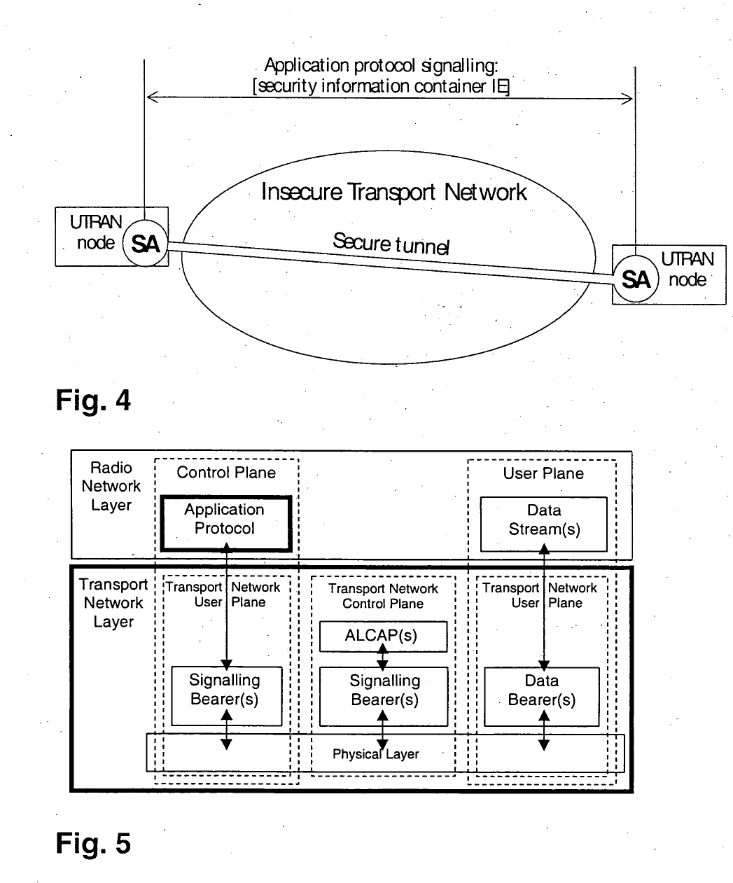

FIG. 4 shows a general diagram indicating an ultimate security environment with SAs in peer UTRAN nodes, as obtained by one of the principles described in the above first to third embodiments. Thereby, a secure tunnel through the insecure transport network between the peer UTRAN nodes can be established based on an application protocol signalling.

FIG. 5 shows a general model of the protocol structure for UTRAN interfaces and those parts involved in the security provision according to the above preferred embodiments. The protocol structure is based on the principle that layers and planes are logically independent of each other. It consists of two main horizontal layers, the Radio Network Layer and the TNL. All UTRAN-related issues are visible only in the Radio Network Layer, while the TNL represents standard transport technology selected to be used for UTRAN but without any UTRAN-specific changes. Furthermore, the protocol structure consists of three vertical planes, a Control Plane (including the above mentioned application protocols and the signalling bearers for transporting application protocol messages) for all UMTS-specific control signalling, a Transport Network Control Plane used for all control signalling within the TNL, and a User Plane for transporting all information sent and received by the user. Further details can be gathered from the 3GPP UTRAN Release 5 specification.

As indicated by the emphasized boxes, the TNL security parameters and/or information is conveyed or obtained based on an application protocol signalling of the Radio Network Layer, while the TNL security is implemented in the TNL.

It is noted that the present invention can be implemented in any radio access network to provide a security function for establishing a secure connection, e.g. an IPSec connection. The names of the various functional entities, such as the RNC or Node B may be different in different cellular networks. Furthermore, other suitable RAN application protocol signalling messages may be used to convey the security information required for conveying or creating an SA, or any other information. In general, the container in the application protocol can be used for conveying transparently (i.e., the application protocol is not concerned of the contents of the container but it only conveys it as an information element in its protocol message) any information that is to be used by the transport layer protocols below the application protocol. The container allows to exchange transport information without the need for another (transport layer) protocol for that purpose. The information in the container can be related to security but it can also be related to something else like Quality of Service needed in the transport layer, etc. The names used in the context of the preferred embodiments are not intended to limit or restrict the invention. The preferred embodiments may thus vary within the scope of the attached claims.

1-29. (Cancelled)

30. A method for providing security in a radio access network between communicating network nodes, comprising the step of
using a signalling message of an application protocol, used for setting up a user stream in said radio access network, for conveying information for deriving or creating a security association between said communicating network nodes.

31. A method according to claim 30, further comprising the step of
providing in a database a mapping information for mapping network node addresses to respective available security associations.

32. A method according to claim 31, wherein said database is a local database in a network node or a centralized database.

33. A method according to claim 31, wherein said conveyed information is an information about the IP addresses and/or UDP ports of said communicating network nodes.

34. A method according to claim 33, further comprising the steps of
checking said mapping information relating to the receiving network node at the sending network node; and
determining a security association based on said checking step.

35. A method according to claim 30, further comprising the step of
determining the security association at the receiving network node by a security information contained within said received message.

36. A method according to claim 35, wherein said security information is a security parameter index (SPI).

37. A method according to claim 35, further comprising the step of providing a predetermined specific information for conveying an additional information required for creating said security association.

38. A method according to claim 30, wherein said conveying step is performed by using an existing security association for said signalling message.

39. A method according to claim 30, wherein said conveyed information is conveyed within an information field of said signalling message.

40. A method according to claim 39, wherein said information field is a container.

41. A method according to claim 39, wherein said information field is a transport layer address information field.

42. A method according to claim 39, wherein said information field is a predetermined specific information field.

43. A method according to claim 30, wherein said deriving or creating is performed during set-up of said communication.

44. A method according to claim 30, wherein said security association is signalled separately for both communication directions.

45. A method according to claim 30, wherein said application protocol of said radio access network is a RNSAP, NBAP or RANAP protocol.

46. A method according to claim 30, wherein said signalling message is an NBAP message, an RANAP message or an RNSAP message.

47. A method according to claim 30, wherein the security association is determined at the sending node based on the type of user stream.

48. A method according to claim 47, wherein said type is determined based on a service of said user stream.

49. A method of conveying an information between network nodes, said method comprising the steps of:
a) providing a transparent container information element in an application protocol message; and
b) using said transparent container information element for conveying said information not targeted for said application protocol but for the transport network layer and its protocols.

50. A system for providing security in a radio access network comprising at least two network nodes, wherein said system is arranged to use an information conveyed in a signalling message of an application protocol, used for setting up a user stream in said radio access network, to derive or create a security association to be used in a communication between said at least two network nodes of said radio access network.

51. A system according to claim 50, comprising storing means for storing a mapping information for mapping network node addresses to respective available security associations.

52. A system according to claim 51, wherein said storing means is a local database in a network node or a centralized database.

53. A system according to claim 50, wherein said conveyed information is an information about IP addresses and/or UDP ports of said communicating network nodes.

54. A network node arranged for providing security in a radio access network, wherein said network node is arranged to use an information conveyed in a signalling message of an application protocol, used for setting up a user stream in said radio access network, to derive or create a security association to be used in a communication between said network node and another network node of said radio access network.

55. A network node according to claim 54, said node being arranged for checking said mapping information and for determining a security association based on the checking result.

56. A network node according to claim 54, said node being arranged for determining a security association at the receiving network node by a security information contained within a received message.

57. A network node according to claim 56, wherein said security information is a security parameter index exchanged by said communication nodes during set-up of said communication.

58. A network node of claim 56, wherein said information is a security parameter index of a given security association.
